(19) United States
(12) Patent Application Publication
(10) Pub. No.: US 2009/0299905 A1
(43) Pub. Date: Dec. 3, 2009

(54) Web enabled color management service system and method

(75) Inventors: Lalit Keshav Mestha, Fairport, NY (US); Peter Stanley Fisher, Pasadena, CA (US)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: Xerox Corporation, Norwalk, CT (US)

(21) Appl. No.: 12/127,649

(22) Filed: May 27, 2008

(51) Int. Cl. G06Q 30/00; H04L 9/32

(52) U.S. Cl. 705/76; 705/1

(57) ABSTRACT

The present application discloses a system and method of critical web-based service architecture at a high level for color management systems in which services can be rendered remotely at very low cost to the end user using a cloud computing based computer network architecture. Service supported include Remote RIPPing, remote profiling, remote IQ analysis for diagnosing color problems, Remote System Problem Action Requests (SPAR) evaluation and patch distribution, remote copy match solutions; multi-machine matching; remote Half-tone downloads; other remote file processing; and image or photo indexing and retrieval.

### BACKGROUND

A multi-functional peripheral equipment environment incorporates a plurality of devices including a computer and at least a printer, a copier, a scanner, a fax or the like. Printing is performed by sending and receiving image related data generated by a computer and user, then performing image processing and rendering, routing the data to a print device, and then performing a print to a peripheral printing device.

However, as the network of devices grows in number as more devices are added, the speed of the printing often is decreased. The users on such a system may have differing demands with respect to the quality of the prints and the quantity or volume of prints needed.

By incorporating a cloud computing environment and configuration, the network system may provide more flexibility to the users and may also result in higher speed processing of printing jobs.

### BRIEF DESCRIPTION

The present application discloses a system and method of critical web-based service architecture at a high level for color management systems in which services can be rendered remotely at very low cost to the end user using a cloud computing based computer network architecture. Service examples are covered in some detail and include: 1) Remote RIPPing for RIPPing large jobs; 2) Remote Profiling solutions which may include supplying customer specific GCRs, Gamut mapping and Spatial & image based gamut mapping solutions over the web; 3) Remote IQ analysis for diagnosing color issues/problems; 4) Remote System Problem Action Requests (SPAR) evaluation and patch distribution via the web; 5) Remote CopyMatch solutions; 6) Remote multi-machine matching; 7) Remote Half-tone downloads; 8) Other Remote Print File Processing; 9) Image/photo indexing & retrieval. A new method for the application of the present web-based color management service paradigm is also disclosed.

### BRIEF DESCRIPTION OF THE DRAWINGS

FIG. 1 illustrates the layout of the cloud network;

FIG. 2 is a flow chart to illustrate the method claim;

FIG. 3 illustrates the connectivity offered;

FIG. 4 illustrates the customer communication protocols; and

FIG. 5 illustrates the color management services offered.

### DETAILED DESCRIPTION

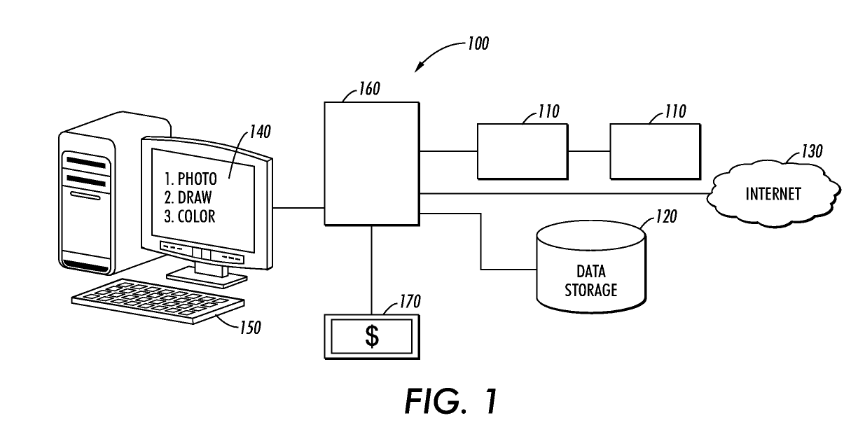

With referent to FIG. 1, if people and businesses can rely on central stations or reliable remote services to fulfill most of their print related computing services, they may be able to reduce the money spent on their own computer hardware and software. This may seem against today's PC based computing environment. With Google's new datacenter infrastructure, or cloud/grid computing, this paradigm may shift, particularly for high performance computing needs, There may be cheap and plentiful computing available in the future with the rise of internet-based computing. To capitalize on this new paradigm, we need to develop web-based services for Color Management Systems early on. Our color print customers are broad based and have many different color management needs. These can range from those who are extremely color critical as in offset markets to those who want just pretty pictures

In a two-tier layered color management approach, Color Critical Customers are served differently than the Color Basics Customers. The Color Critical Customers are technically savvy and want enhanced color management capability not only to build profiles but to make custom or preferred edits. These customers may have Xerox devices or a mix of marking technologies in their shop and they want to color manage or color match across all devices. By providing generic color management software such as a destination profile, as shrink-wrapped solution, customers would be allowed to choose the parameters in the software package and then customize it to their device. These customers may have the skill and knowledge to support their own color management service using the software package supplied by Xerox or through third party support recommended by Xerox. The majority of customers are Color Basics Customers who just want good saleable color using a standard set of industry software package and the ability to use it on their device from time to time. They would buy one color management package and may not need any tuning thereafter. However, many Color Basic Customers have small business, constrained by capital and have numerous special computing needs for speed and performance. The present embodiment is expected to serve all our customers as the economics of service reduce the money spent by customers on their own computer hardware and software when it matures.

Several examples of service applications are covered in some detail. Revenue generation may also occur through web-based color management of these service applications.

Cloud computing is a type of grid computing architecture for the creation and delivery of application as a service over a network. The cloud refers to a large public network such as, but not limited to, the Internet or a corporate intranet. The concept is also referred to as cloud computing in Wikipedia at: http://en.wikipedia.org/wiki/Cloud_computing; as an Elastic Computing Cloud in Amazon.com; as storage cloud service at Sun Microsystems. Companies such as Google, HP, and Microsoft each have different businesses around the cloud computing architecture.

Cloud may consist of several parts 100. The cloud may contain a network of a plurality of computer servers 110 containing data storage memory 120 connected together. The plurality of computer servers may be perceived as working in harmony as one machine, and this is called virtualization. The system may also access the Internet 130 or any other such network device. The cloud may also contain a service catalogue which consists of a list of services available to the cloud user 140. The cloud may also contain at least one user interface 150 which enables a user to select a service from the catalog of services available across the network. The cloud may also contain system management 160, which manages the resources available to the user. Management functions may consist of, but are not limited to, assigning user ID's and passwords, granting or denying access permissions to users with respect to which services an individual user or class of user may use, routing traffic, the adding, deleting or changing of software available on the network, and layout design of the user interfaces. The cloud also may contain monitoring and metering tools 170 which attribute resources to an individual user or group of users or measure the amount of time, number of services, or amount of billable increments used by the customer user. This may also be used to bill the customer or feed data to a connected customer billing system. The applications run somewhere on the “cloud”. Architecture allows the end users to develop, deploy and run applications. Applications can run fast and the data is transferred on a highly secured network.

One element of the web-based color management architecture at different levels is the instantiation of basic infrastructure needed for providing the service. There are data grids being proposed and developed for scientific computing elsewhere which include multiple levels. The architecture mirrors the grid architecture for providing web-based color management service. At the lowest level called “fabric” not shown, basic components that make up the system include storage systems, networks and computational servers or systems

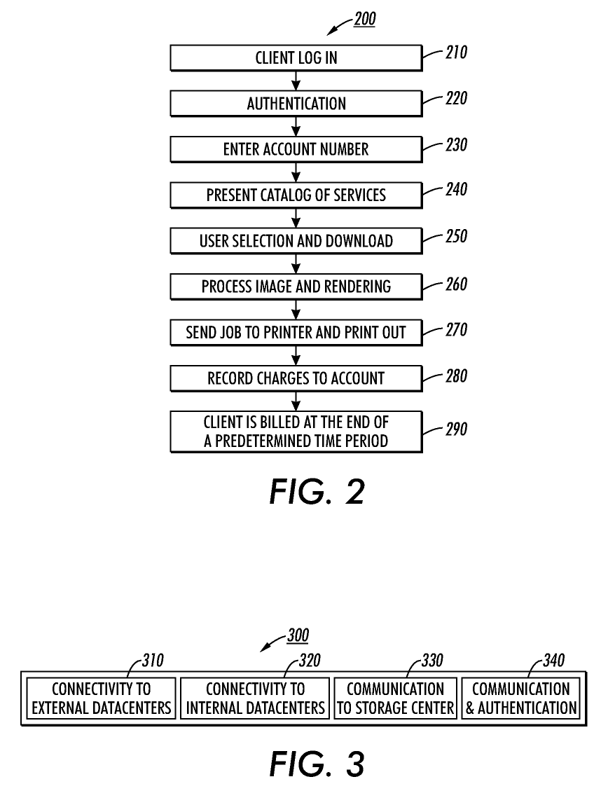

FIG. 2 illustrates the process for enabling the use of the system 200. The user or client must first log on 210, which shall require user entry of an authentication means such as, but not limited to, a user ID, a password, retina scan, fingerprint, thumbprint, palm print, voice recognition, any of a plurality of biometric recognition schemas, and the like. Once a user is authenticated 220, user may be prompted to enter an account number, a client number, a work number and the like 230. The system may check the authentication and the account number with a resource manager to determine which services this specific user is authorized to access, and then present the user with a catalog of services to select from 240 on a computer terminal or other type of display means. The user shall make a selection and gain access to a service, which may download the appropriate software 250. The system may receive data input from the user and process or render an image in accordance with the user's instructions 260. Upon completion of a job, the user shall instruct the system to send the job to a printer 270 and a printer shall complete this request. The total amount of time and the extent of services used by the user may be quantified and recorded 280, such that the user may be billed 290 at either the present time before the user is able to retrieve the printing, or later at a later time period.

FIG. 3 illustrates the “connectivity” layer 300 which contains various standard protocols for communication and security. The connectivity may facilitate connection to external datacenters 310 such as, but not limited to, outside databases, server farms and the like. The connectivity may facilitate connection to internal datacenters 320 such as, but not limited to, data warehouses, disaster recovery sites and the like. This layer may also facilitate the communication to the data storage center 330 and the authentication process 340. At the “resource” level are services related to managing individual resources, for example storage of customer files, network and computation resource management.

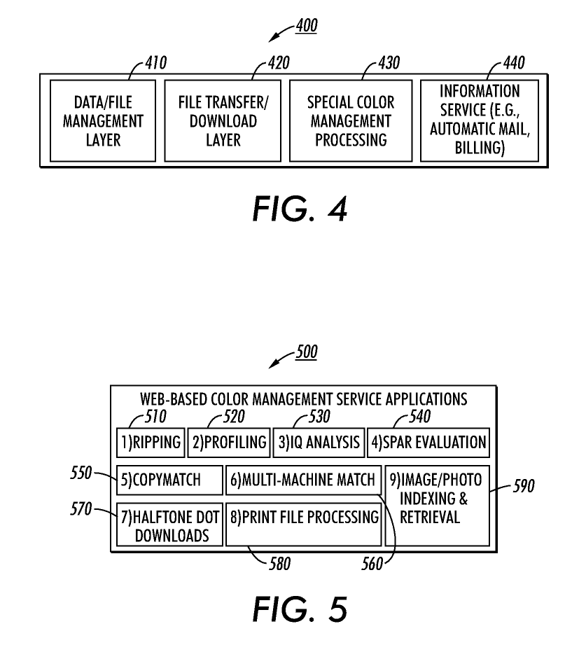

FIG. 4 illustrates the collective or “customer communication” layer 400 which may include a data or file management layer 410, a software systems for reliable file transfer and downloads 420, special color management processing 430, and mailing & accounting information and information service communication with the customer 440. Special color management processing section 430 includes specific instructions for processing color management jobs for particular service at the customer communication layer.

FIG. 5 illustrates the application layer 500 may be visible to the customer. Details of the color management services and the business are described next.

Remote RIPPing for RIPPing large jobs 510 enables users to specify their requirements, download their images or jobs, to the corporate site over the secure network. Initially, corporate site may not involve the computing cloud utilizing large datacenters.

Customers may pay a nominal fee to receive the RIPPed image. At the corporate site, a dedicated person or a computer may take the image, complete the RIPPing process and then inform the corporate site about the completed service. Once the cloud computing for Xerox applications becomes real, depending on the need for hardware/software sophistication, Xerox may enter an agreement with datacenters to purchase computing on demand over the computing cloud. This may be transparent to the final customer. The business model then becomes identifiable to the software as a service or utility computing model.

The capital-constrained smaller companies have strong incentives to use this kind of remote RIPPing feature quickly. Large customers may also move towards this model as economics improve. Initially, they may pursue a hybrid approach such as in-house RIPPing and remote RIPPing to balance their investments. If most of the business computing shifts to what is known as “computing cloud”, or utility computing, then remote RIPPing may become the norm. Today, the approach by various printing equipment vendors is to sell customers RIP Servers such as HP Indigo Scalable RIP Solution. The problem is that the creative's that are producing the images to be RIPPed are creating input print files of a complexity that is growing faster than customers can handle necessitating increasing the size of the RIP server to the point that it is unaffordable by the customers. Customers either take an inordinate amount of time to RIP the job or they turn away the business. The RIP Service suggested herein would provide RIPPing power unavailable to individual customers at their site due to cost but available via the server. Customers only need such power intermittently, making the cost-per-use make more sense than having servers sitting idle when not in use.

Remote profiling solutions 520 which may include supplying customer specific GCRs, Gamut mapping and Spatial & image based gamut mapping solutions over the web. Printer profiles are used to find the device values needed to make a specified color, and are generally three dimensional colorimetric-to-device look-up tables. Scripts incorporating custom GCR and gamut mapping algorithms is released based on the need.

Gray Component Replacement, or GCR is a process which involves replacing the gray tone in the cyan, magenta and yellow plates, with black ink, during the color separation process. Gamut refers to the range of colors available to a specific output device, such as a laser printer or an image setter. If the color range is too wide for that particular device, it is referred to as ‘out of gamut’. For example, the RGB color range is much broader than the CMYK color gamut, which is what most pre-press output devices use. CMYK is an abbreviation for cyan, Magenta, Yellow and Black, which are the four primary printing inks that make up any full color printing job. Also known as the four process colors. Colors specified using the RGB gamut may often fall out of the gamut range when output on a CMYK device. The profiling software supplied as shrink-wrapped package does not have the capability to down load the GCR from the web in the form of a “starting LUT”. With the service model, new GCRs can be easily incorporated by the customer. Also, to change the gamut mapping algorithm, a new script has to be shipped, which is also not being incorporated in profiling software.

The web-based service can offer multiple options suitable for rendering specific jobs in addition to supplying or downloading the traditional profiling software. For example, the shrink-wrapped profiling software would generally have one GCR, one gamut mapping embedded in the code. There are several GCRs available for use, some give improved toner usage of about 20% and others give good image quality for special tone scales. The out-of-gamut colors are converted to printable colors through a transformation called gamut mapping or gamut compression. Printers have different gamuts and are generally limited when compared to the gamut of the source digital image due to the physical limitations of the printer's colorant. There is no unique gamut mapping method that can satisfy all the requirements such as pleasing color, contrast, lightness, chroma, hue etc. Some gamut mapping algorithms offer nice features in at least one region of the gamut and suffer from offering the same advantage in other regions, whereas others do the same in other regions. Generally during the design stage, a compromise is applied to satisfy many requirements. Once the web-based color management architecture is in place, choosing and assigning best gamut mapping can be done on a job/image/document basis to render pleasing images. In one embodiment, customers send their sample job & printer model to the web. Corporate service person may soft-proof the sample job with several profiles with several gamut mapping options. Best one may be chosen. New profiling software with customized gamut mapping algorithm may be downloaded for the customer to use. In a second embodiment, customers submit their sample job and the updated printer model with the inline spectrophotometer, or ILS, to the web or utility datacenter. Apply different profiling solutions (GCRs, gamut mapping combinations), perform soft-proofing on that screen and select the best one and download the best profiling solution. All this work may be done by the customer. Corporate service center may intervene, to address problems/questions. Protocols for servicing spatial and image based gamut mapping solutions can also be implemented in a similar fashion with web-based remote profiling service. As the processing required creating high density & high quality profiles increase, remote profiling on a high performance computer may become necessary. With web-based service, low budget customers can still enjoy high performance color management. Some customers may wish to run both remote profiling and remote RIPPing feature sets. The architecture may allow this kind of multiple functions.

Remote IQ analysis 530 for diagnosing color issues/problems, Inline Full Width Array, or FWA sensors, consisting of thousands of optical sensors arranged in linear array can be used to perform remote image quality analysis and failure diagnosis. Remote diagnostics can lower run cost of our printers.

Having an FWA in our printer can allow the capture of high quality output image samples that can then be uploaded to the web-based service for analysis of image quality. This can allow the automatic identification of current or potential problems, reducing the cost of servicing of our printers.

The image analysis can result in the generation of new printer profiles that can be downloaded and incorporated into the machine for improving image quality.

Remote SPAR evaluation and patch distribution via the web 540 such as System Problem Action Requests (SPARs) are used by customers and the Xerox field to report problems with Xerox systems, hardware and software. These can result in software “patches” being provided to fix the particular problem. These patches are generally communicated via email to the particular Service Engineer.

The use of a server-based approach would allow these SPARs to be generated quickly, communicated to the server, and, after development, patches to be distributed automatically to all customers, greatly reducing the time-to-repair.

Remote CopyMatch solutions 550 help customers who often receive a print file to print and a sample of sample hard copy to facilitate the matching of the colors. The hard copy might have been done on an offset press, a competitor's piece of equipment or a Xerox color press. It might have been printed recently, as in the case of an offset printer needing to print a few thousand additional copies of a run, or some time ago, like the last time a particular promotion was done. In any event, the desire is for the colors achieved in printing the file to match the colors in the hard copy.

CopyMatch software allows the hard copy to be scanned on a calibrated customer's scanner. It then processes the file so that the resultant printed colors match that of the scanned hard copy. The processing of the file is time-consuming, requiring a significant amount of computer power, suitable to the server concept described herein. With the server concept, the scanned file would be uploaded to the server along with the print file. The file would be processed and a new file sent back to the customer for printing.

Remote multi-machine matching 560 is a service very similar to remote profiling, but with a difference that the color management service provider may receive measured colors for a test print file on two or more machines. In one embodiment, customers send their sample job & printer models for multiple machines to the web. Corporate service person may soft-proof the sample job with several profiles with several gamut mapping options. Best one may be chosen for individual machine. New profiling LUT may be downloaded for the customer to use on each machine.

Remote Half-tone downloads 570 are a remote service which can also provide latest half-tone dot downloading feature for a particular job. In one embodiment, customer may submit the job. The Corporate service person may access a database and retrieve information to facilitate making recommendations, make such recommendations for the best halftone to use from the database, and then convey recommendations to the customer.

Other Remote Print File Processing 580.are Xerox color presses which incorporate ICC profiles in providing accurate colors. Other non-ICC technologies create color-managed files that can be printed on Xerox and other presses. The color management is done by sending sets of color patches to the subject printer and reading them with an inline spectrophotometer. The resultant color values are then communicated to a server, which uses them to develop a transform from the input print file to a color-managed print file for printing. This transform is then applied to the input file to yield the color-managed file. This process is time-consuming and computer processing-intensive and is, thus, conducive to a server approach. The print file would be sent to the server. The patch files to be printed would be sent from the server to the printer to be printed with the color readings sent back to the server. The resultant color-managed file would then be sent to the printer for final printing.

Remote Image/photo indexing and retrieval 590 is a service where a customer downloads numerous images to a corporate storage space. Images could be in quantities of millions. A natural language based query may be supplied to the server to retrieve collection of images that correspond to that query. For example, images with “umbrella”, or “beach scene” etc., can be stated in the UI for retrieval. Special Image Retrieval algorithm may bring out several images with umbrella or beach in a thumb nail form for viewing. The user can then go to select the right image, and then down load the image for inclusion in their job.

The business model would be one where customers would have a pre-approved budget and an account. The customer would access the various services on the server and the server would keep track of service usage by the user. The customer would be billed monthly based on their usage. The charges would be based on the compute power used and the value of the feature invoked. The value would be established based on the perceived value to the customer of that feature. In cases where a third party application was used, such as ORIS, the system would automatically send a royalty to the vendor. With this model, customers can receive color management resources from Xerox as a service provider much like electric service at home.

In summary, the present application addresses the problem of getting up-to-date color management services to customers in a low cost manner. The technology provides capability to customers that they could not otherwise receive due to cost, timeliness, lack of resources, and the like. The present application may have impact beyond the current description. Other capabilities as they are developed by Xerox could be added to this service. Different pricing algorithms could be developed.

It may be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A computer operable software system for facilitating a color management computing network comprising:
at least one customer communications component for facilitating communication between a customer and the network;
at least one data communications component for facilitating data connectivity;
at least one user input device to facilitate user data input;
at least one selection component to enable a user to select a service to be used;
at least one server to facilitate user interaction with a plurality of peripheral devices;
at least one management server to assign passwords, authenticate users, and determine which printing services a user is permitted to access;
at least one database storage medium for retaining information or software programs related to color processing; and
at least one time and cost management module to record a quantity of services consumed.

2. The system of claim 1, wherein the service to be selected and used comprises at least one of RIPPing, Profiling, IQ Analysis, SPAR Evaluation, Copy Match, Multi-Machine Match, Halftone dot downloads, Print file processing, Image and Photo indexing & retrieval

3. The system of claim 1, wherein the customer communications component comprises at least one of: a data or file management layer, a software systems for reliable file transfer and downloads, a special color management processing, and a mailing & accounting information and information service.

4. The system of claim 1, wherein the data communications component comprises at least one of: an external datacenters, an internal datacenters, a data storage center, or an authentication process.

5. The system of claim 1, wherein the time and cost management module contains a billing module for charging the customer money for the quantity and quality of services consumed by the user.

6. A method of network computing comprising:
performing a client log on;
authenticating the identity of a user;
entering an account number
presentation of a catalog of available services
user selection of a service prompting a software download;
interaction of a user with the software to facilitate image processing and image rendering;
sending the job to a printer and printing the job as output;
recording the amount in time, resources, or money of the job; and
billing the client for the services consumed.

7. The method of claim 6, wherein the service to be selected and used comprises at least one of RIPPing, Profiling, IQ Analysis, SPAR Evaluation, Copy Match, Multi-Machine Match, Halftone dot downloads, Print file processing, Image and Photo indexing & retrieval.

8. The system of claim 6, wherein the customer communications component comprises at least one of: a data or file management layer, a software systems for reliable file transfer and downloads, a special color management processing, and a mailing & accounting information and information service.

9. The system of claim 6, wherein the data communications component comprises at least one of: an external datacenters, an internal datacenters, a data storage center, or an authentication process.

10. The system of claim 6, wherein the time and cost management module contains a billing module for charging the customer money for the quantity and quality of services consumed by the user.

11. The system of claim 6, wherein the services are free and not billable.

12. The system of claim 6, wherein the authentication determines which services are available to the user.

13. The system of claim 6, wherein the account number determines which services are available to the user.

14. A computer operable apparatus for managing the presentation, selection, routing of color processing jobs in a network system comprising:
an input device for accepting a client log on;
a device for authenticating the identity of a user;
an input device for accepting an account number
a display device for presenting of a catalog of available services;
a device for enabling a user to select a service;
a device to enable software to download;
a manipulation device to enable a user process and render an image;
a printer;
a resources usage tracking device for recording the length of time a software product was in use; and
a device for computing a bill for delivery to a user.

15. The system of claim 14, wherein the service to be selected and used comprises at least one of: RIPPing, Profiling, IQ Analysis, SPAR Evaluation, Copy Match, Multi-Machine Match, Halftone dot downloads, Print file processing, Image and Photo indexing & retrieval.

16. The system of claim 14, wherein the customer communications component comprises at least one of: a data or file management layer, a software systems for reliable file transfer and downloads, a special color management processing, and a mailing & accounting information and information service.

17. The system of claim 14, wherein the data communications component comprises at least one of: an external datacenters, an internal datacenters, a data storage center, or an authentication process.

18. A system for performing Internet based cloud computing specifically to offer each and every one of the color management services on a selection list of services comprising:
RIPPing;
Profiling;
IQ Analysis;
SPAR Evaluation;
Copy Match;
Multi-Machine Match;
Halftone dot downloads;
Print file processing; and
Image and Photo indexing and retrieval.

19. A Internet based system for performing each and every color management services on a selection list comprising:
RIPPing;
Profiling;
IQ Analysis;
SPAR Evaluation;
Copy Match;
Multi-Machine Match;
Halftone dot downloads;
Print file processing; and
Image and Photo indexing & retrieval.

20. Computer software for performing each and every color management services on a selection list comprising:
RIPPing;
Profiling;
IQ Analysis;
SPAR Evaluation;
Copy Match;
Multi-Machine Match;
Halftone dot downloads;
Print file processing; and
Image and Photo indexing & retrieval.
